(19) United States
(12) Patent Application Publication
(10) Pub. No.: US 2011/0148260 A1
(43) Pub. Date: Jun. 23, 2011

(54) Tub Cover Design and Fastening Means of Tub Cover to Tub

(76) Inventor: Alejandro Arzate Silva, Santiago de Queretaro (MX)

(21) Appl. No.: 12/875,588

(22) Filed: Sep. 3, 2010

(30) Foreign Application Priority Data
Dec. 18, 2009 (MX) MX/A/2009/014045

(51) Int. Cl. D06F 39/14; D06F 39/00; E06B 7/00

(52) U.S. Cl. 312/228; 49/503; 49/70

(57) ABSTRACT

A cover for tub for a washer, the tub having a mouth and at least two balconies over which a cover is placed, wherein said cover comprises a housing channel placed on the periphery of said cover, which houses the upper end of the tub; at least one pair of locks facing each other on the periphery of said cover, wherein said locks have on their upper part some wedges; where each lock snaps unto the flange of the balcony of the tub: maintaining a drive tension between the lock and the balcony of the tub.

### RELATED APPLICATIONS

This application claims priority from Mexican application Serial No. MX/a/2009/014045 filed Dec. 18, 2009, which is incorporated herein by reference in its entirety.

### FIELD OF INVENTION

The present invention relates to washers, particularly top loading washers, which have a cabinet and in particular, top loading washers with covers for the internal tub.

### BACKGROUND

The present invention relates to washers, particularly top loading washers, which have a cabinet with four grasped suspension bars and having a lower portion having a shock absorber where these are inserted into an equal number of ears set there for this purpose on the tub, which lend support to the tub and additionally are a good support system for the vibrations caused during the wash, rinse and centrifuge motions. Thus, the tub houses in its interior a perforated basket, this in turn contains an agitator in concentric shape; the agitator's shaft, which is mechanically connected to an electric motor suspended in the bottom portion of the tub.

The tub, in addition to bearing the weight of the water and articles to be washed, also withstands the static and dynamic charges generated by the wash or centrifuge action, where these charges in some cases can be so large that, they can deform the tub's geometry, knowing that normally these are manufactured via thermoplastic injections, the most popular of which is propylene, so that, for example, when the basket is turning at a high speed to create centrifuge, it is very common that the load of objects to be washed which are held in the basket cause the system unbalance, which in turn cause the basket not only to have a rotational movement, but will also cause translation within the tub, sometimes even grating with the tub's inner wall which is an undesirable condition of the design. If to this, you also add the considerable deformation of the tub's mouth, the gap between the tub and the basket is greatly reduced, thus it is desirable to design a tub for a top loading washer with strong rigidity, without discounting ease of manufacture, using thermoplastics such as polyethylene or polypropylene, which help to absorb, distribute and transmit the distinct forces and efforts generated by various washing and centrifuge cycles.

Several efforts have taken place in this area with this objective in mind, a stand out being Peyton W. Douglas' U.S. Pat. No. 3,604,225 which describes a tub cover which could restrict the flow of foam to the exterior of the washer, helping contain foam and splashing as well as the washing mixture within the washer's tub, wherein said design also has an overflow duct on its upper part which is connected to a hose which will transport the liquid or washing mixture towards the lower part of the washer avoiding the electric components from becoming wet; also shown is a nose, not integrated to the tub's cover, coupled to a hole set there for this purpose coupled on its extreme posterior with a hose which is directly connected to the water valve; the mentioned tub's cover is placed in crown shape over the tub and grasped by resilient metal staples. The above mentioned design encounters different setbacks, for instance, we can point to the assembly which contains the resilient staples as well as the complex overflow duct, and the complex geometrical configuration which makes for difficult manufacture among others.

Also worth mention, is Paul Gregory Hall's AU2006235808 patent publication which deals with a bombing system which is fastened to the lower portion of the tub; FIG. 2 shows a cross section of the lower portion of the tub where the reinforcements of the inferior external part of the tub can be seen, where a pancake type motor is grasped emphasizing the bomb's assembly, the part of particular interest in this tub being the use of lobes in the tub's superior part which are aligned with the reinforcement of the support ears.

Jonathan David Hartwood's et al EP 1 783 264 A2 published application which presumably shows in FIG. 2, the same tub as Hall's, where there appear a pair of lobes aligned with the ear reinforcements, wherein said lobes were presumably designed to create more space for the basket inside the tub, given their number, as it only has two lobes which do not significantly increase the area's rigidity in the tub's mouth, allowing a larger space to the basket as well as to the tub's cover which can house a grid, window or passage in the precise additional area created by the lobes intended to transport chemicals deeper into the tub to be mixed with greater ease. Even so, though the tub shown in both documents at a simple glance appears to have strong reinforcements at the ears making them better able to hold heavy loads, however, no concern seems to be shown to avoiding the deformation to the tub's mouth, so to this end, the present invention's tub's cover design will greatly help to reinforce the mouths.

Given the above discussion, there is a need to develop a tub with higher rigidity yet using the traditional manufacturing materials, thereby reducing cost which also allows for larger baskets to be held due to lesser deformities and thus transmits more efficiently the efforts to the suspension bars with shock absorbers, and also avoids the scraping between the tub and the basket during centrifuge, where larger baskets allow for larger washing loads as well as water and detergent (mixes water with chemicals or additives), allowing for larger washing loads in an equal volume sized cabinet, this being the purpose of this invention.

### BRIEF DESCRIPTION OF THE INVENTION

Derived from the experience of designing and manufacturing washers it is noted that the tub, far from being solely an object which contains water and detergent, has structural functions as well. It supports the basket's assembly which is aligned with the tub in its symmetrical axis, as well as to the transmission or reduction box which can be fitted to the agitator; it also supports the electric motor, the extraction pump, hoses, overflow ducts etc. This entire group afore mentioned plus the suspension bars are known as the sub-washer. The tub itself hangs from four suspension bars whose lower part have a shock absorber mechanism, whereas the higher part of said suspension bars are attached to the upper corners of the cabinet which statically and kinematically support the sub-washer. The lower part of the suspension bars are fastened to the tub by means of ears lodged in the shock absorbers, this system allows the tub at least three degrees of freedom, because if it were a rigid assembly, the washer would tend to “walk” or jump, not being capable of softening the vibrations emerging from its own operation, such as those being created from the agitation of the wash load itself or the centrifuge stages, this is why the tub has a robust system of reinforced ears with veins which run along its length as well as the tub's circumference. Knowing that water's own weight exerts a force on said wall, coupled with certain washing conditions which require hot water for proper stain removal or to activate chemicals or detergents mixed in the wash, said temperatures can reach near 60□C, which can cause a considerable re-softening of the equatorial area of the tub's cylindrical wall inflating it to a balloon shape, not a desirable deformation because when this happens, the tub's mouth itself tends to deform inwardly reducing the gap or area between the basket and the tub, which in turn creates friction due to scraping between these two parts during the agitation and specially centrifuge motions which leads to wear out and possible permanent damage as a hole can be formed on the cylindrical wall where the repeated and prolonged scraping take place.

With the purpose of avoiding the tub's mouth from inward deformation, said area can be reinforced, a way of doing this is to use the tub's cover as a structural component of said tub, not only as a retaining barrier to the foam or washing mixture contained in the tub, as the tub's cover, object of the present invention has the ability of withstanding as well as distributing the forces generated or transmitted in the tub's upper part, granting the tub's mouth a higher rigidity thus avoiding deformation of the tub's mouth which could be caused by the basket's rotations, widening the gap between the tub and the basket precisely in the area where the basket's nodding occurs considerably avoiding the friction due to scraping between the tub and the basket as well as evenly deflecting the forces to the tub's cylindrical wall. Additionally, said tub's cover has at least one spout which allows for the pouring of chemicals or washing mixture released from the dispatch or those which are directly poured by the operator (depending on the washer model), between the tub and the basket, this way ensuring that the chemicals reach the bottom of the tub so that there, they may be diluted with water or the washing mixture, homogenizing the mixture. This helps avoid spots on the wash load articles themselves as placing high concentrations of the liquids previously mentioned, could damage the textiles. It is also worth mentioning, that the tub's cover previously mentioned, has a liquid deflector, this deflector or nose spout directs the fluid from the tub's bottom or directly from the admitting valves towards the textiles allowing them to become wet in an even manner.

In another vein, the tub's cover above mentioned, has been given a series of radial nerves which give it greater rigidity as well as allowing for better transmitting of forces, this coupled with ease of assembly on the tub by means of resilient fingers are among other attributes which shall be described in detail later to attain a novel tub cover.

### BRIEF DESCRIPTION OF DRAWINGS

The drawings which accompany the present description and which help describe it are set forth in the following.

FIG. 1 is an isometric cross-section of a sub-washer.

FIG. 2 displays a tub, valve suspension bars, an overflow duct, a spray hose and the tub's cover separated from the tub.

FIG. 3 shows a tub, valve suspension bars, spray hose, overflow duct and tub's cover assembled unto the tub.

FIG. 4 is an isometric upper view of the tub's cover.

FIG. 5 is an isometric lower view of the tub's cover.

FIG. 6 shows an isometric view of a detail of the tub's and cover's assembly.

FIG. 7 shows an isometric view of a detail of the tub's and cover's assembly.

FIG. 8 shows an isometric view of a detail of the tub's and cover's assembly highlighting the lock.

FIG. 9 shows an isometric view of a detail of the tub's and cover's assembly highlighting the lock.

FIG. 10 shows an isometric view of a detail of the lock, springs and wedge.

FIG. 11 shows an isometric view of a detail of the lock, springs and wedge to highlight the forces or vectors placed on the lock.

### DETAILED DESCRIPTION OF THE INVENTION

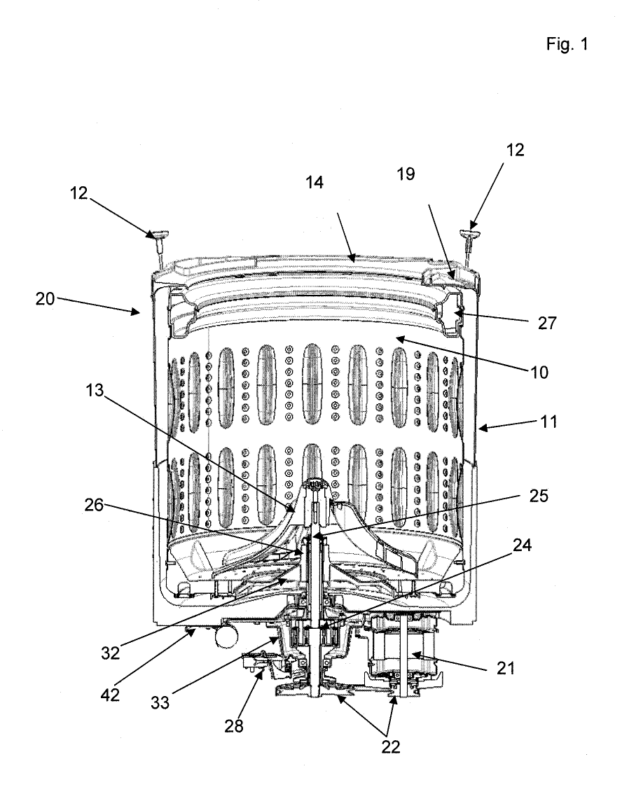

The washing machine being described in the present invention, illustrated in FIG. 1, is a top loading machine or vertical axis, and possesses a cabinet from which four suspension bars are attached 12. Said suspension bars 12 support the tub's weight 11 with the additional accessories to said cabinet. Said suspension bars in addition of supporting static charges, mitigate the dynamic charge through shock absorbers present in its lower part, which help dissipate the vibrations caused by the washing motions. Thus the tub 11 is hung from the suspension bars 12 by means of ears (not shown) placed in the lower portion of said tub 11. The remaining peripheral equipment is mounted on said tub 11, such as the motor 21, in a preferred embodiment, a planetary gear for reduction 24, which, in an alternative embodiment of the present invention, can be omitted thereby adjusting the pulley relationship 22; in this form, the pulley 22 with the largest diameter will be adjusted over the internal shaft 25 which will receive energy proceeding from the electric motor 21 thanks to the arrangement of pulleys 22 and band. In a preferred embodiment, the shaft 25 on its upper part shall be coupled to a planetary gear for reduction 24 with the purpose of reducing angular speed, thereby accomplishing greater par. The exiting shaft from the planetary gear for reduction 24 is reintegrated into a shaft 25, on whose upper part the agitator 13 is placed on. In an alternative embodiment the internal shaft 25, has a pulley with the largest diameter coupled to its lower part 22. The interior of the hollow shaft 26 houses the internal shaft 25. Said hollow shaft 26 is mechanically coupled to a clutch 28, which can make both shafts 25, 26 rotate together or independently. Also, said hollow shaft 26 is mechanically coupled to the basket's center called the “hub” 32, so that when shafts 25, 26 are clutched and rotating together, the hollow shaft 26 shall transmit energy to the basket 10 so that it turns along with the agitator 13.

The basket 10 is crowned with a balance hoop 27 which counteracts the unbalancing caused by the shifting of the wash load inside the basket 10. In a preferred embodiment, the tub 11 on its upper part is joined to a covered tub which houses a grill 19 and a spray deflector 18. The cabinet itself is covered with the main cover 30 which covers the washer's upper part 20, said main cover 30 serves as a support to the crest 31 where the electric components such as the controls 40, the interrupting or relief drivers, the pressure switch 41 etc. are housed as well as the washer's cover or lid 29 through which the items to be washed shall be loaded.

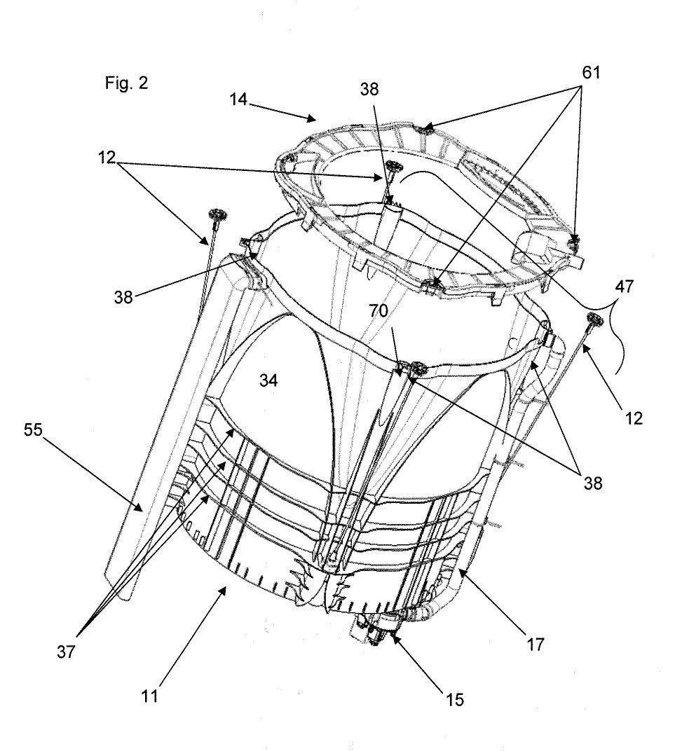

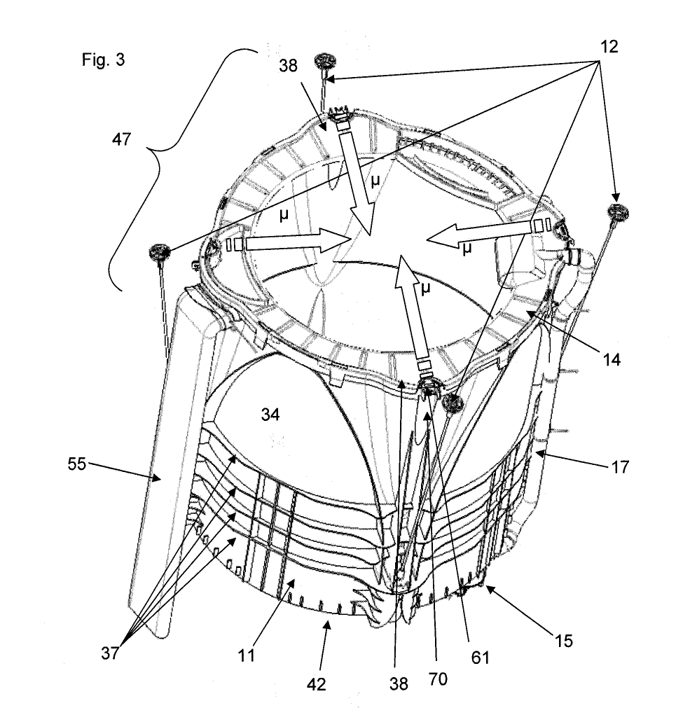

FIGS. 2 and 3 show a tub 14 in which a pump 15, as well as a spray hose 17, the four suspension bars 12 as well as the over-flow hose can be seen. Particularly, FIG. 2 shows a cover 14 separated from the tub 11. Conversely, FIG. 3 shows the cover 14 assembled on the tub 11. FIG. 2 allows a glimpse at the tub 11 without its cover 14. Although the tub 11 shown possesses two separate reinforcements in the area of the tub's mouth 47, by virtue of having the cover 14 on, helps avoid deformities being caused in the referred area. Knowing that when the tub 11 reaches a maximum level of liquid or washing mixture coupled to the weight of the articles of the wash load plus the dynamic charges generated by the agitation can cause considerable deflections on the tub's bottom 42, which, as they are transmitted through the cylindrical wall 34 of the tub 11 can themselves create a considerable narrowing in the area of the tub's mouth 47. Therefore, coupled to the design shown in the tub 11 which has lobes 38 as well as reinforcements 37, it is of great usefulness to assemble a cover 14, not only for the purpose of containing splashes or the foam created by agitation and dehydration but also to aid in evenly distributing the forces which reach the area of the tub's 11 mouth 47, thereby preventing deformation to said mouth 47 area and aiding consistently in maintaining the gap distance between the tub 11 and the basket 10, reducing the risk of scraping between the basket 10 and the tub 11 during the centrifuge and dehydration stages. This also allows a decrease in the gap, whether this allows the placement of a larger basket 10 within the same size tub 11 or alternatively, the placement of a smaller tub 11 for a similar size basket 10. This allows for water conservation or washing mixture, considering that the smaller the tub 11 or the lesser the gap distance between the tub and the basket, imply a lesser amount of water is required for the wash as this means a lesser geometric volume for the tub 11 which allows a certain quantity of articles to be washed.

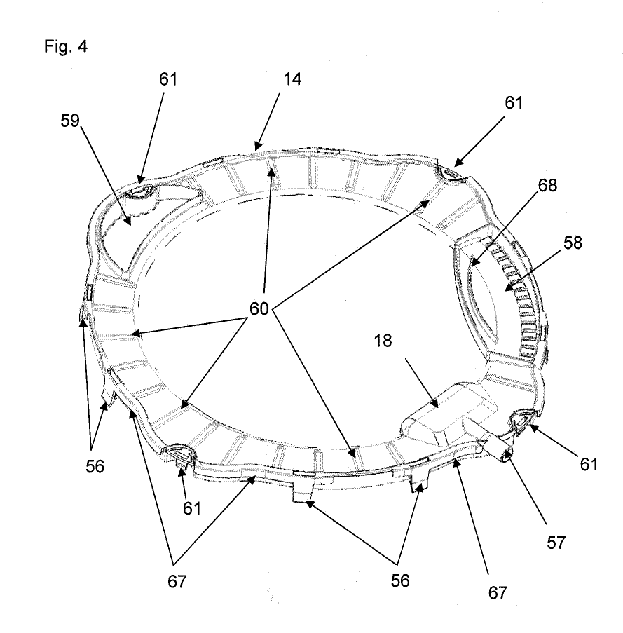

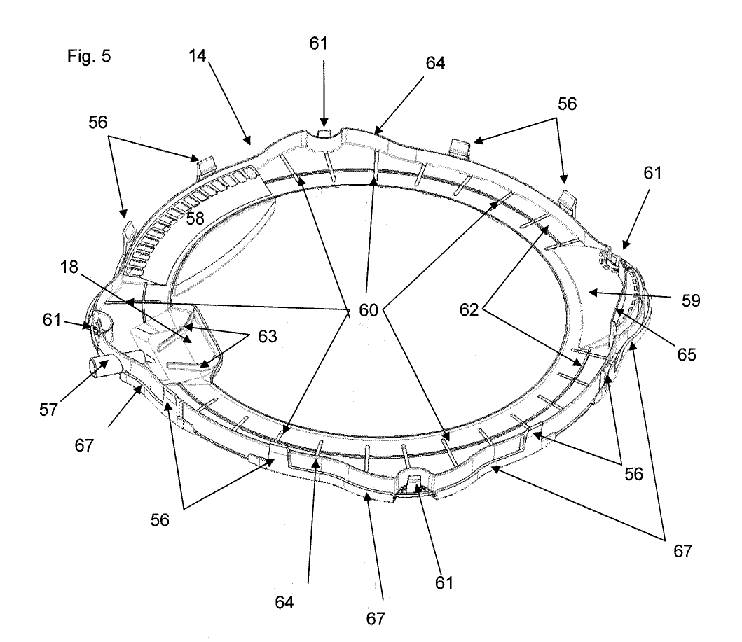

FIGS. 4 and 5 help illustrate in detail the cover 14 of the object of the present invention. FIG. 4 represents an overhead view of the cover 14, from which we can glimpse into the grid for chemicals 58, which is located precisely underneath the chemical dispenser (not shown). This, thanks to a flow of water which runs thru said chemical dispenser, the additives, detergents or chemicals are dragged by the water guiding them to the chemical grid 58, which receives them and further guides them between the tub 11 and the basket 10. Said chemical grid has a series of windows or apertures in the form of grids, and it is through these, that the washing mixture passes through, which in this instance contains a high concentration of chemicals. It is for this reason that said washing mixture is deposited in the bottom of the tub 42, so that it may be diluted with the water volume accumulated there, because if the washing mixture were to be directly poured in high concentration onto the textiles, these latter, could be damaged by the chemical attack, resulting in spots, color fading, fiber damage, and undesirable fading among others. The above mentioned chemical grid also has a barrier which resembles a barrier rail in a bullfighting ring, wherein said fence allows the liquids within the geometric volume of the chemical grid 58 to be contained, avoiding the overflow into the baskets' 10 interior, and thus preventing the flow of washing mixture as well as dissipating its energy at this point. In the same FIG. 4, a collector 59 is highlighted, whose base or bottom is traced in an inclined plane, whose lower part which is in close proximity to the cover's 14 periphery, has a series of holes which allow for the flow of fluid to the tub's 11 bottom. In order to avoid splashes or possible fluid deviations towards the basket 10, the lower part of the collector 59 has a curtain 65, which runs along the length of the holes of above mentioned collector at such a height level that it does not allow for the transport of splashes or fluid into the basket's 10 interior, guiding this at all times towards the tub's 42 bottom. Said collector works in washer models which do not have a chemical dispenser, so that the operator has to pour the chemicals directly into said collector, where they are received and then guided towards the tub's 11 bottom thanks to the holes placed on the lower part of the inclined plane, thus avoiding contact with the articles from the wash load placed in the basket 10, aiding in the mixing and dissolving of the above mentioned chemicals in the tub's 11 bottom. Another function of said curtain 65 is to avoid splashing residual water drops adhered to the balance ring 27 or basket 10 which can find a path towards the spout 48 and thus be transported by the overflow sleeve 55 onto the floor. If a certain volume of liquid or drops were to gather, these could form a puddle visible to the operator, this being highly undesirable. So that above mentioned curtain 65 deters the liquid drops or splashes emanating from the basket 10 or balance ring 27 when said basket is turning. This thanks to the curtain 65, so that the splashes or drops do not reach the spout 48 being instead guided into the tub's 11 bottom.

FIG. 4 in light of FIG. 5 allows our attention be directed to the spray nose integrated on the cover. Said spray nose 18 has a cavity which helps houses the fluid from the nose duct 57 unto which on its free end, the spray hose 17 is coupled to. This in turn, can be connected to a pump which sucks the fluid from the suction pit found in the tub's 11 bottom 42, or in an alternative embodiment can be directly connected to the flow valves 45. In this way, the fluid which is led to the nose duct 57 passes through this until it finds itself within the spray nose's 18 cavity, and this cavity as can be seen in FIG. 5 has a wall which is found precisely in front of the spray nose's 57 exit; said wall in this particular instance has a curvature which allows the fluid to slide and change its direction at an angle between ninety and one hundred and forty degrees, thus leading the volume towards the basket's 10 interior. To aid in this task, the spray nose's 18 cavity also has a pair of deflectors 63 which ease the sorting of flow as well as widening it so that it may have a better exit width, which allows there to be an improved water curtain with proper inclination and width angles.

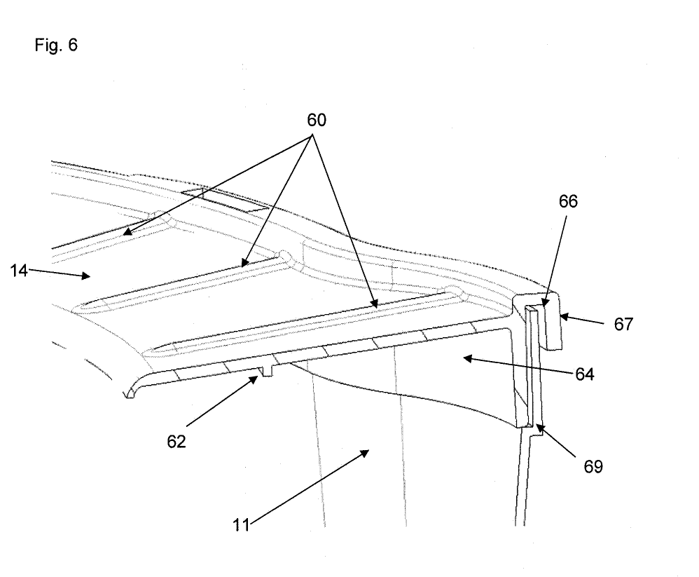

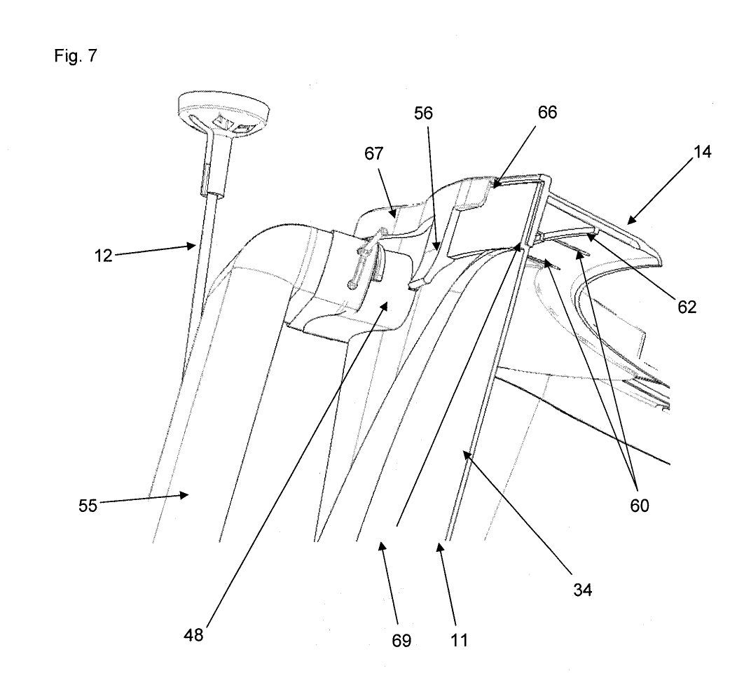

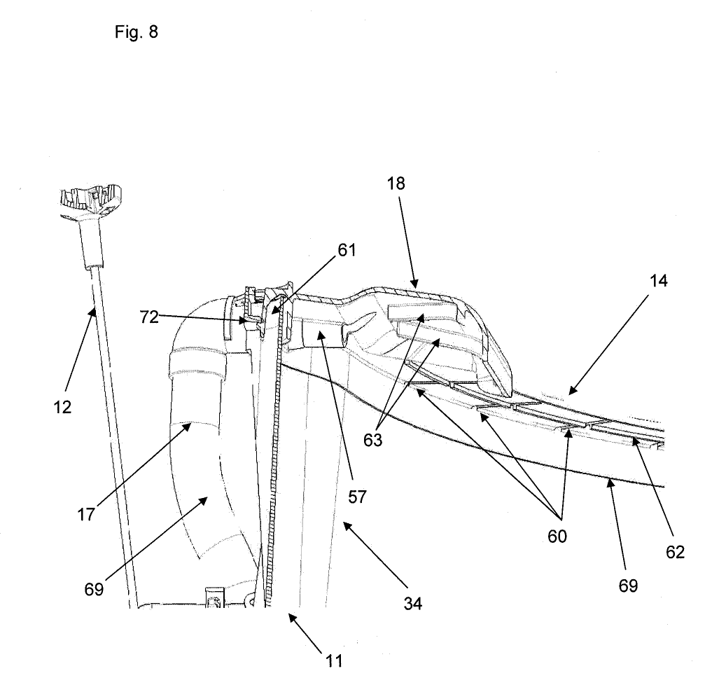

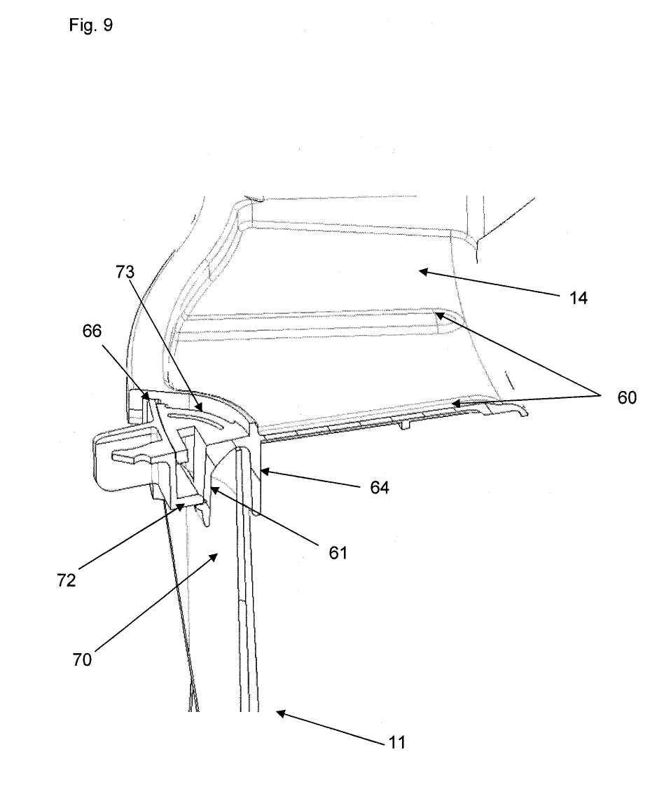

In FIGS. 4 and 5 the radial reinforcements 60 can be discerned as well, which can be found both on the upper and lower faces of the cover 14, where said reinforcements 60 on the upper face appear as undulations surrounding the ring which conform the outer and inner periphery of the cover 14 (see FIG. 6). This geometry, in addition to being pleasant to the sight, allows for a better force distribution given the curve described. On the other hand, the cover's 14 lower face has reinforcements in the form of radial ribbing in a concave cross section, being evident that the appearance of the lower face is of secondary importance, focusing mainly on the rigidity of the design using a minimum amount of material. Also apparent on the cover's 14 lower face is the diametric rib 62, which allows for force distribution via the diametric medial curve between the inner and outer periphery of the cover 14, thus granting the cover 14 greater rigidity, only lightly increasing its mass.

Placing attention again on FIG. 5 focusing on the outer perimeter, an edge skirt plate 64 can be seen, which runs almost without breaks along the cover's 14 outer perimeter. The above mentioned skirt plate 64 is erected at a height determined by the tub's 11 seat, with the understanding that the skirt plate 64 on the edge serves as an internal coupling to the tub's 11 mouth 47 settling the edge skirt plate's 64 free end, an assembly which shall be discussed later. The parapet 67 is found on the cover's 14 outer border and it runs in intermittent fashion along the cover's 14 outer border, keeping always a constant distance between the edge skirt plate 64, since between these two the lodging canal 66 is formed through which the upper part, mouth 47 or the tub's 11 free end is introduced. Additionally, the geometry of the above mentioned canal 66, together with the skirt plate 64 and parapet 67 give the cover's 14 periphery rigidity helping transmit and distribute through the lodging channel 66 forces emanating from the tub's 11 mouth 47, thus avoiding deformities both in the mouth area 47 as well as on the cover 14 itself.

Resilient fingers 56, can be found scattered approximately every ninety degrees on the above mentioned parapet 67, these are anchored on one end on the said parapet 67 and in cantilever similar to a diving board where one end is free, which at its point most distant from the cover 14 on the inside part, has a lock, hook or wedge which is latched to the tub's 11 seat 69, wherein said resilient fingers 56 are flexed when the cover 14 is placed on the tub 11 where the mouth's 47 wall of the tub 11 has been housed inside the cover's 11 channel 66. The resilient fingers 56 have a length such that when the cover 14 has finished its route on the mouth's 47 wall of the tub 11, the lock, hook or wedge of the resilient finger 56 is coupled just underneath the seat's 69 edge making a “snap” thus ensuring the assembly between the tub 11 and cover 14 (see FIG. 6, 7).

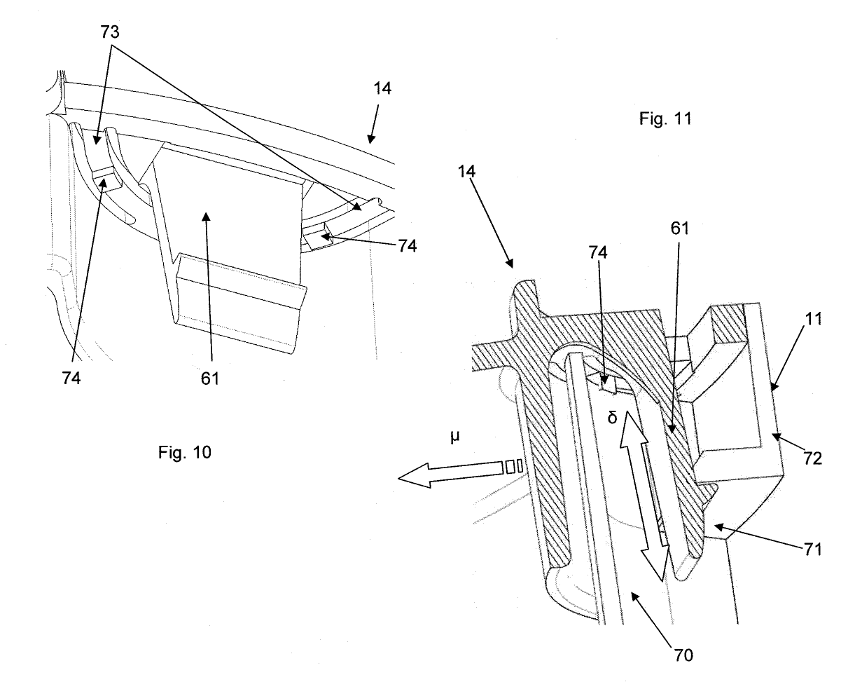

In an alternative embodiment of the present invention, there can be an extra set of locks 61 to reinforce the assembly between the tub 11 and the cover 14. Additionally, an extra set of resilient diving boards with a hook or wedge on the vertical wall's surface close to the farthest part of the cover 14 can be found. These locks 61 make a “snap” in radial direction opposite to the resilient fingers 56 to counteract the resulting vector or force which could be subjected on the cover 14 or the tub 11, a vector or force which runs in a radial form over a horizontal plane in the tub's 11 mouth 47 area. Thus, locking receptors 70 are placed on the tub 11 in channel-like fashion (see FIGS. 2, 3). Said locking receptors 70 in addition to creating space to receive the locks 61, also give the 11 wall 34 of the tub 11 rigidity. The upper part of the locking receptor 70 has a particular geometry like a circumference arch (in another embodiment being able to obtain any other geometry) in secant form to the above mentioned arch circumference and on the internal part of the wall's 34 upper part in the tub's 11 mouth area 47 there is a protuberance similar to a balcony 72 which on its free end has a wedge-shaped recess. Thus, the lock 61 is introduced into the lock receptor 70 in a passage formed by the channel, which itself is formed by the lock receptor on the tub's 11 wall 34 and between the tub's 11 peripheral border of the mouth 47 itself, where the balcony protrudes in wedge fashion 72. Thus, when the lock 61 passes through, it is flexed towards the lock's receptor channel 70 upon making contact with said balcony with the wedge-shaped recess 72. Once the lock's 61 own hook or wedged recess is in the lower face of the above mentioned balcony with the wedged-shaped recess 72, this snaps and locks thus ensuring the assembly between the tub 11 and the cover 14. The set of locks 61 above mentioned upon assembly unto the tub 11 present an interference grade maintaining a thrust tension μ between the arm in cantilever resilient from the lock 61 against the balcony 72 formed in the tub 11, this thrust tension is contrasted in reaction to each one of locks 61 maintaining a state of adjustment which avoids vibrating noises between the cover 14 and the tub 11 (see FIGS. 3, 11). The lock can attain a good vector magnitude μ (thrust tension) since in its upper part it has some resilient springs 74 which grant it greater strength, alleviate the forces formed on the base thus prolonging the cycles before fatigue stress can occur, first absorbing axial forces and secondly, the horizontal ones. Additionally, said springs 74, in an alternative embodiment, on the lower face, have at least one wedge 74 which exerts a force on the tub's 11 upper border, which ensures that the lock 61 once in gear with the balcony's 72 flange 71, experiences a tension 6 (see FIG. 10), which causes the tub's 11 superior border to always be in contact with the channel's 66 internal face or with the cover's 14 inferior face, thus impeding the flow of liquid or washing mixture towards the tub's 11 outer and additionally avoids the knocking between tub 11 and cover 14.

In this way, having an assembly between tub 11 and cover 14 which does not require seals, glue, binders, or any uniting method such as screws, rivets, spin Weld, ultrasound or similar method, the cover 14 is simply placed in the correct position on the tub 11 and pushed downwards, to where the resilient fingers 56 and the locks 61 (in its case) snap unto the tub 11, avoiding extra components and easing assembly. Also, a cover 14 is used which can be obtained by means of a molding via injection process using a thermoplastic material, preferably a polypropylene or polyethylene, which will simplify its assembly, creates low cost, helps avoid deformations as well as distributes forces in the tub's 11 mouth area 47.

Thus having described the present invention in sufficient detail, it is found to have a high degree of inventive activity, being novel and allowing a glimpse to its evident industrial application, the following claims are being made.

1-13. (canceled)

14. A tub cover for a washer tub having a mouth and at least two balconies over which the cover is placed, said cover comprising:
a. a housing channel placed on the periphery of said cover which houses an upper end of the tub; and
b. at least one pair of locks facing each other on the periphery of said cover, wherein said locks have on their upper end at least one wedge, wherein each lock is configured to affixingly engage a flange of a corresponding one of said at least two balconies, wherein each lock is further configured to maintain a drive tension between the lock and the tub balcony along a first direction.

15. The cover of claim 14, wherein said at least one wedge comprises a resilient member configured to exert a force on an upper border of the tub along a second direction, the force being exerted upon engagement of the lock with the flange of the corresponding one of said at least two balconies.

16. The cover of claim 14, further comprising a spray hose.

17. The cover of claim 16, wherein said spray hose comprises a nose duct.

18. The cover described in claim 14, further comprising a chemical grid.

19. The cover of claim 18, wherein said chemical grid comprises a barrier rail.

20. The cover of claim 14, further comprising a collector.

21. The cover of claim 20, wherein said collector comprises a curtain.

22. The cover of claim 14, further comprising at least one resilient finger configured to snap unto a seat of the tub.

23. The cover of claim 14, further comprising at least one radially-extending reinforcement disposed on the cover.

24. The cover of claim 14, further comprising at least one diametrically-extending rib disposed on the cover.

25. A household washer appliance comprising the cover according to claim 14.

26. The cover of claim 14, wherein the first direction comprises a generally radial direction and the second direction comprises a generally axial direction.
